(19) United States
(12) Patent Application Publication
(10) Pub. No.: US 2002/0007552 A1
(43) Pub. Date: Jan. 24, 2002

(54) Apparatus and method of manufacturing a battery cell

(76) Inventors: Robert W. Singleton, Plant City, FL (US); Craig Nelson, Melbourne, FL (US)

Correspondence Address: Enrique G. Estevez, Allen, Dyer, Doppelt, Milbrath & Gilchrist, P.A., 255 South Orange Avenue, Suite 1401, P.O. Box 3791, Orlando, FL, 32802-3791, US

(21) Appl. No.: 09/939,135

(22) Filed: Aug. 24, 2001

Related U.S. Application Data
(60) Provisional application No. 60/228,220, filed on Aug. 25, 2000.

(30) Foreign Application Priority Data
May 25, 1999 (US) PCT/US00/14446

(51) Int. Cl. H01M 10/04; B23P 19/10

(52) U.S. Cl. 29/623.3; 29/623.2; 29/730

(57) ABSTRACT

A battery cell manufacturing apparatus comprises a vacuum indexing conveyor for vertically suspending an anode material web, wherein a die punch is used to form a discrete anode from the anode material web. A pick and place mechanism is operable with the die punch for positioning the discrete anode between first and second separator webs for subsequent lamination. A laminator vertically receives the separator webs suspended for longitudinally extending them a force of gravity for smoothing out web surfaces adjacent the discrete anode carried therebetween prior to lamination of the separator webs to the discrete anode. A cathode assembly section includes a vacuum conveyor for guiding cathode material webs and vertically suspending them for die punching discrete cathodes which are then placed onto exposed outside surfaces of the vertically suspended separator webs in alignment with the anode laminated therewith. The discrete cathodes are then laminated to the vertically suspended separator webs for forming a laminated battery cell, which webs are then cut to form a discrete battery cell.

### RELATED APPLICATIONS

This application claims priority from and is a national phase entry application for international application No. PCT/US00/14446, which has a priority date of May 25, 1999. This application additionally claims priority from co-pending U.S. provisional application Ser. No. 60/228,220 which was filed on Aug. 25, 2000. All referenced priority applications are incorporated herein by reference in their entirety.

### FIELD OF THE INVENTION

The present invention relates to fabrication of flat battery electrodes (cathodes and anodes), and, in particular, to the fabrication of the electrodes from continuous webs, applying them to a separator material, and laminating the electrodes and separators to form discrete battery cells.

### BACKGROUND OF THE INVENTION

The present invention relates to Polymer Lithium Ion (PLI) battery technology as described, by way of example, with reference to U.S. Pat. No. 5,470,357 to Schmutz et al. for a “Method Of Making A Laminated Lithium-Ion Rechargeable Battery Cell,” owned by Bell Communications Research, Inc. (Bellcore). The present invention, however, is not restricted to Bellcore-type technology, and can be applied to many other battery technologies. However, the Bellcore example is useful and is widely known in the industry.

Those of skill in the art are aware of the chemistry of the anode and cathode electrodes, and the chemical composition of the separator materials, along with required process steps. Typically, a lamination process is performed by a pressing of electrode elements between flat plates at elevated temperature, or through calendering rollers at elevated temperature.

Those skilled in the art have made a multitude of attempts at developing reliable manufacturing systems for the PLI battery technology, but results have had design drawbacks that have not produced the production throughput, yields, and performance reproducibility desired. Typically, electrode dimensions and separator dimensions are such to provide an edge to edge stack up capability. In practice, however, it has been demonstrated that this is not practicable.

Further, electrodes are typically manufactured by coating a web with an electrochemical material. The web is generally made from an a thin expanded metal mesh, either copper or aluminum. Once the electrodes are cut from this web there remains exposed metal around the edges of the electrodes. If metallic filaments are not cleanly cut, they form burrs. Once a stack up of electrode elements is made and pressed together, these burrs can contact each other and form an electronically shorted cell. There is a need to have the separator extend beyond the dimensions of the electrodes (a nominal 1 mm, by way of example) to provide an electrically insulating protection from any burrs that might form. Poor cutting tools and techniques that form substantial burrs will not be corrected by this improvement.

By way of further example, it has been reported in the art that crystalline growth (dendrites) can occur at an edge interface as the battery is charged and discharged. Since these crystals are salts of the electrolyte and electrode chemistry, they are conductive, and therefore, cell short circuits can occur. Having the separator material extend outside of the electrodes, and once laminated, sealing the anode therebetween, removes this failure mode from the battery.

Consequently, assembly machine designs that produce cells with web materials being laminated in a continuous fashion and having the finished cell cut from the laminate without the extended separator, are no longer considered for this manufacturing application.

Therefore, several concepts that considered the extended separator were developed. These were basically divided into two efforts. By way of example, a first effort produced discrete anodes, cathodes, and separator parts, stacking one atop the other with fixturing means (one embodiment featured a fine mist spray of adhesive material), then delivering the stack to lamination. A second effort produced discrete electrodes, applied heat to a separator web to energize the surface of the separator (make it “tacky or “sticky”), and applied the electrode to this heated web, eventually forming a stacked up cell, then delivered the stack to lamination.

Both approaches exhibited problems in execution. The first effort was difficult as the separator material is extremely thin (typically 0.001″) and has no rigidity, so cutting and handling techniques are quite demanding. In addition, the necessity to spray on fixturing adhesive incurs the difficulties of maintaining repeatable dispensing, machine cleanliness, operator safety issues of fumes in the environment, and the necessity to remove evaporable materials in the adhesive from the assembled cell prior to further processing steps, as these materials can adversely effect cell performance.

The second effort was a much improved process, but was typically executed with the web path in the horizontal plane. This made web tracking, web flatness, and web tensioning difficult to achieve.

While the Bellcore patent teaches the use of both flat plate lamination and calender roll lamination, the preponderance of effort has been spent on roll lamination. There are several factors that adversely affect roll lamination from typically being a reliable manufacturing process. By way of example, as the web or stack up of cell materials enter the rolls, pressure is applied. The pressure is a function of the thickness of the introduced materials relative to the gap setting of the rolls. Since coating thicknesses of the electrode materials can vary, the applied lamination pressure will vary, and if the materials stack up, height becomes less than the minimum gap setting, no lamination will occur. As the web flows through the rolls, the material is squeezed together with entering material being thicker than exiting material. This extrusion effect can induce stresses in the web, mis-registration of cathode to anode to cathode, and wrinkles, by way of example, and, in the end, not produce uniform lamination of the layers. Typically, rollers are essentially in “instantaneous” contact with the web, a point contact, as the web flows through the rollers. As a result, temperatures of the rollers can be high relative to the temperature limits of the materials to attempt reliable bonding. Accurate and repeatable temperature measurement and temperature control of the contact surface of the rolls is difficult as the rolls are in continuous rotational motion.

It is well known that for platen lamination with heated metal plates either in an oven or in a heated press, lamination uniformity suffers with the use of rigid press plates that cannot distribute forces evenly over single or multiple stacks of cell components of varying heights. Additionally, flat platen lamination has typically been applied to the entire stack of five layers of the cell, requiring heat to travel through the parts to reach the anode, thus inducing a temperature gradient across the stack, and requiring relatively higher temperatures than needed to attain the short lamination dwell times necessary for a manufacturing process.

Further, there is a need to span the requirements for laboratory development (10 parts per minute), pilot production lines (50 ppm), and fully automated high speed manufacturing systems (150 ppm and up) in a cost effective and reliable manner. The present invention satisfies this and the aforementioned needs.

### SUMMARY OF THE INVENTION

In view of the foregoing background, it is therefore an object of this invention to provide an apparatus and method for preparing battery electrodes with minimum metallic burrs. It is further an object to mechanically fixture the electrodes to a separator without adhesives or thermal distortion for fully laminating the layers to provide highly repeatable stacking tolerances, uniform lamination temperatures and pressures using short lamination dwell times. It is yet another object to minimize waste (scrap) of the electrode and separator materials.

These and other objects, advantages, and features of the present invention are provided by a manufacturing apparatus comprising a first conveyor for vertically suspending a first electrode material web, a first shaper for forming a first discrete electrode from the first electrode material web, and means operable with the first shaper for positioning the first discrete electrode proximate a separator web. A first laminator is provided for laminating the separator web to the first discrete electrode for forming a first laminated electrode carried by the separator web. The first laminator vertically receives the separator web vertically suspended for longitudinally extending the separator web by a force of gravity for smoothing out web surfaces adjacent the first discrete electrode carried thereby prior to lamination of the separator web to the first discrete electrode. A second conveyor vertically suspends a second electrode material web for a second shaper to form a second discrete electrode from the second electrode material web. Positioning means positions the second discrete electrode onto an exposed surface of the vertically suspended separator web, wherein the second discrete electrode is in alignment with the first laminated electrode carried thereby. A second laminator laminates the second discrete electrode to the vertically suspended separator web for forming a laminated battery cell carried thereby. The second laminator is operable with the positioning means for vertically receiving the separator web having the second discrete electrode carried thereon. A cutter is positioned for receiving the separator web having the second discrete electrode laminated thereto, and cuts the separator web for liberating a discrete battery cell from the separator.

A method aspect of the invention includes manufacturing a battery cell by vertically suspending a first electrode material, an anode material web, by way of example, forming a discrete anode from the anode material web, juxtaposing the discrete anode with a separator, by way of the example herein describes, between first and second separator webs, vertically suspending the first and second separator webs for longitudinally extending the first and second separator webs by a force of gravity for smoothing out web surfaces adjacent the discrete anode carried therebetween, and laminating the first and second separator webs to the discrete anode for forming a laminated anode carried by the first and second separator webs. A second electrode material web, cathode webs by way of example as herein described, is vertically suspended for forming first and second discrete cathodes from the cathode material web. The first and second discrete cathodes are juxtaposed at exposed outside surfaces of the vertically suspended first and second separator webs, wherein the first and second cathodes are in alignment with the laminated anode carried therebetween. The first and second discrete cathodes are laminated to the vertically suspended first and second separator webs for forming a laminated battery cell carried by the first and second separator webs. The first and second separator webs are then cut for liberating a discrete battery cell therefrom.

As herein described by way of example, a cathode comprises all electrode chemistry coated in a layer of copolymer material, laminated to an aluminum foil or mesh grid current collector. An anode comprises electrode chemistry also in a copolymer material laminated to a foil or mesh grid copper current collector. A separator comprises a thin coating of a polymer composition including vinylidene fluoride and hexafluoropropylene, and a plasticizer (dibutyl phthalate, by way of example), coated on a mylar release film.

The electrode coating on the current collector does not cover the entire metallic surface, as clean, bare metal tabs are used as part of the electrode to allow electrical connection to the cells. Therefore, there is a need to maintain and support bare edges of the metallic web throughout the assembly process. The mesh materials are quite typically fragile. For one manufacturing process, as herein described by way of example, both the electrode materials and the separator materials are manufactured and wound onto a core, so that the materials can be dispensed into the assembly machine.

As are herein described, features of the invention include a system and process for preparing flat battery electrodes from a continuous web, vacuum indexing of servo driven conveyors to accurately feed the web material, employing a vertical web path through all stations, and minimizing scrap on die punches. Zero clearance for a male/female die punch is achieved with zero clearance stripper plate for burr free electrode preparation. Heated vacuum chuck transfer mechanisms are used to heat electrodes, activate the separator surface, and fixture the electrode to the separator with no adhesive materials and no thermal distortion. Conformal flat platen lamination is vertically disposed and processed with controlled lamination parameters in multiple stages, separator to anode lamination with multiple hits, followed by cathode to separator lamination with multiple hits.

Structure from Process

Battery cell manufacturing costs are reduced by minimizing consumption of raw materials, by operating at rates in the order of 150 parts per minute, with a capability for higher rates. All cells are made within desired manufacturing tolerances with an edge guide and an inspection capability.

The embodiment of the present invention herein described provides burr free die punching and separator dimensions that exceed typical electrode dimensions, both of which prevent internal cell short circuits. A lamination process provides for a uniform fusion of materials without damage or distortion, elimination of voids that can create varying electrical performance and cell failure, repeatable cell to cell electrical performance, and maximizes the materials ability to perform from an electrochemical perspective.

### BRIEF DESCRIPTION OF THE DRAWINGS

One embodiment of the present invention, as well as alternate embodiments, are described by way of example with reference to the accompanying drawings in which:

FIG. 1 is a schematic view of one embodiment of the present invention for producing a battery cell;

FIG. 1A is a front elevation view of one embodiment of the present invention including an anode preparation phase thereof;

FIG. 1B is a front elevation view of one embodiment of the present invention including a cathode preparation phase thereof;

FIG. 1C is a front elevation view of one embodiment of the present invention including a battery cell discharge phase thereof;

FIG. 2 is an exploded view of elements making up one battery cell;

FIG. 3 is a web format for single electrode die punching;

FIG. 4 is a web format for dual tabs out electrode die punching;

FIG. 5 is a web format for dual tabs in electrode die punching;

FIG. 6 is a top view of the electrode discharge vacuum indexing conveyor showing a dual tabs out electrode path with a six up grouping;

FIG. 7 is a side view of an electrode preparation module;

FIG. 8 is a side view of a reciprocating heated vacuum chuck electrode assembly station, and platen lamination station;

FIG. 9 is a side view of a high speed turret indexing heated vacuum chuck electrode assembly station;

FIGS. 10A, 10B, and 10C illustrate partial top plan, right side elevation, and front elevation views of a guide controller and vacuum conveyor, respectively, employed in FIGS. 1A and 1B;

FIGS. 11A, 11B, and 11C illustrate front elevation, right side elevation, and top plan views of a die punch assembly, respectively, as employed in FIGS. 1A and 1B;

FIGS. 12A, 12B, and 12C illustrate top plan, side elevation, and front elevation views of a cathode die punch operable with the die punch assembly of FIG. 11A;

FIG. 13A is an enlarged cross-section view of a web including anode and separator elements;

FIG. 13B is an enlarged cross-section view of a web including anode and separator elements;

FIGS. 14A, 14B, and 14C are top plan, front elevation, and side elevation views of a laminator forming a part of the one embodiment of the present invention;

FIG. 14D is a partial cross-section view taken through lines 7D-7D of FIG. 7B;

FIGS. 15A, 15B,and 15C illustrate top plan, front elevation, and right side elevation views of one vacuum indexing conveyor embodiment, respectively, employed in FIGS. 1A, 1B, and 1C.

### DETAILED DESCRIPTION OF THE PREFERRED EMBODIMENTS

The present invention will now be described more fully hereinafter with reference to the accompanying drawings, in which operating embodiments of the invention are shown by way of example. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

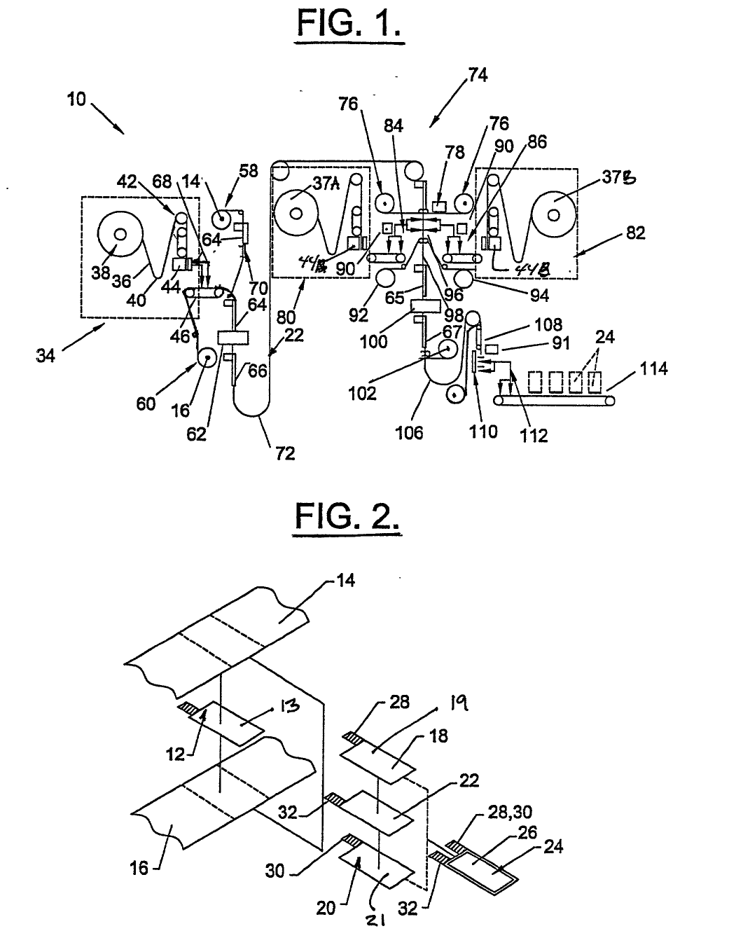

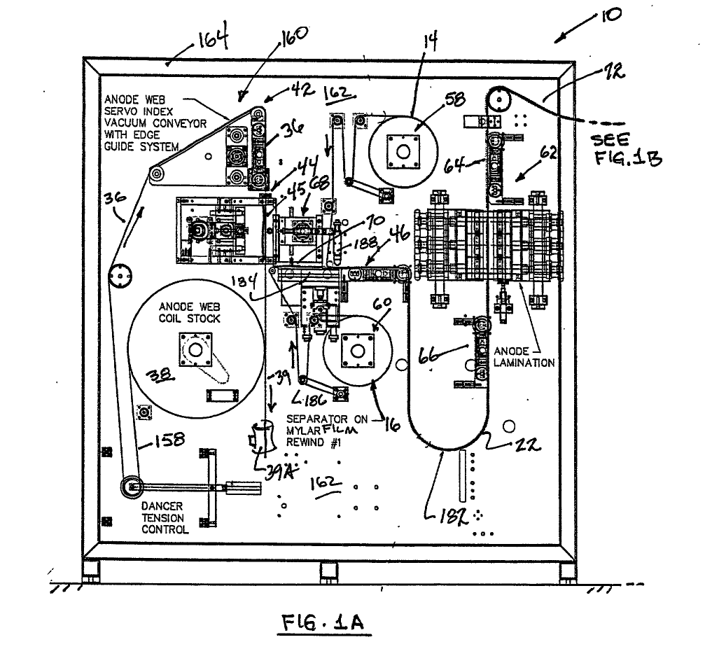

With reference initially to FIG. 1, one embodiment of the present invention may be described as an apparatus 10 for manufacturing a battery cell. By way of example, and with reference to FIG. 2, a graphic illustration of one assembly process includes a prepared cut to size anode electrode 12 (die cut from coated copper), placed between two continuous separator webs, 14, 16. These three layers are then laminated as will be further described later in this section. Subsequently, two cathodes 18, 20 are prepared (die cut from coated aluminum), fixtured to the outside of the separator and anode laminate combination 22, and then laminated in a heated press. A trim cut operation is performed, leaving a laminated cell 24 featuring a border 26 generally 1 mm of separator around the electrodes 18, 20, 22, two aluminum bare metal tabs 28, 30 laid over the top of each other, and one copper bare metal tab 32 adjacent the aluminum tabs 28, 30.

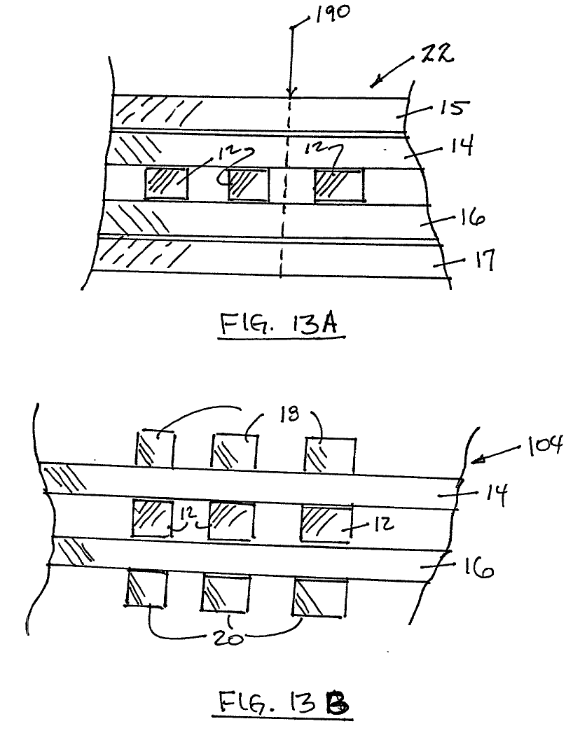

With reference again to FIGS. 1 and 1A, the apparatus 10 may be described as including an anode preparation module 34, having a web 36 of coated copper grid fed from a roll 38 of copper coated grid material into a loop 40. The web 36 is fed vertically downward by a servo driven vacuum indexing conveyor 42 into a die punch assembly 44. The die punch assembly 44 has been shown to be an effective cutter of the webs for forming the electrodes. However, it is expected that one of skill in the art will appreciate that alternate techniques such as water jets, laser beams, cutting blades, and the like may be used. The vertical configuration of the web feed system improves over previous system designs, enhancing web tracking accuracy, tracking stability, and feed (indexing) accuracy thru the apparatus 10 as there are no gravitational forces on horizontal web portions that typically create droop or index to index length variations. As will be further detailed later in this section with reference to FIGS. 12A-12C for a cathode die punch, the die punch assembly 44 engages the web 36 with a stripper plate 45 to clamp it firmly and flatly in position, and a male tool die 47 punches through the web 36, producing an electrode as earlier described with reference to FIG. 2. This electrode, the anode electrode 12 as herein described by way of example in the anode preparation module 34, is then held by a vacuum and transferred from the die punch assembly 44 to a horizontal servo driven vacuum indexing conveyor 46.

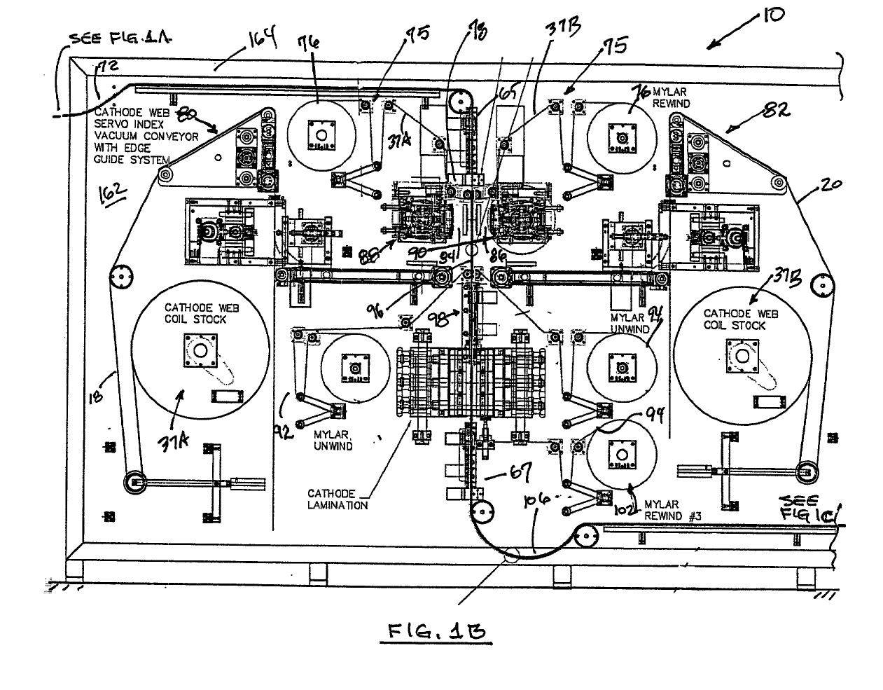

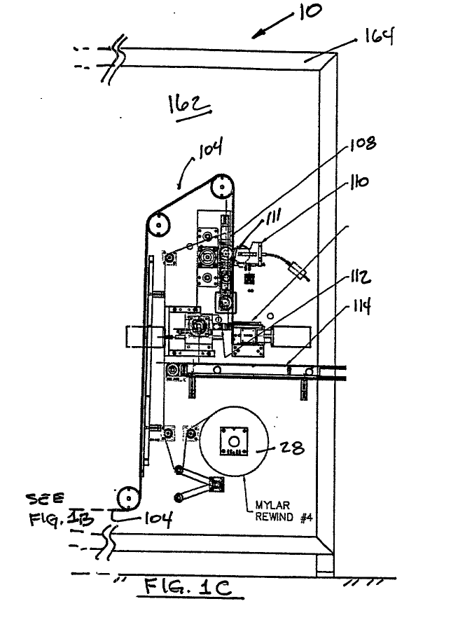

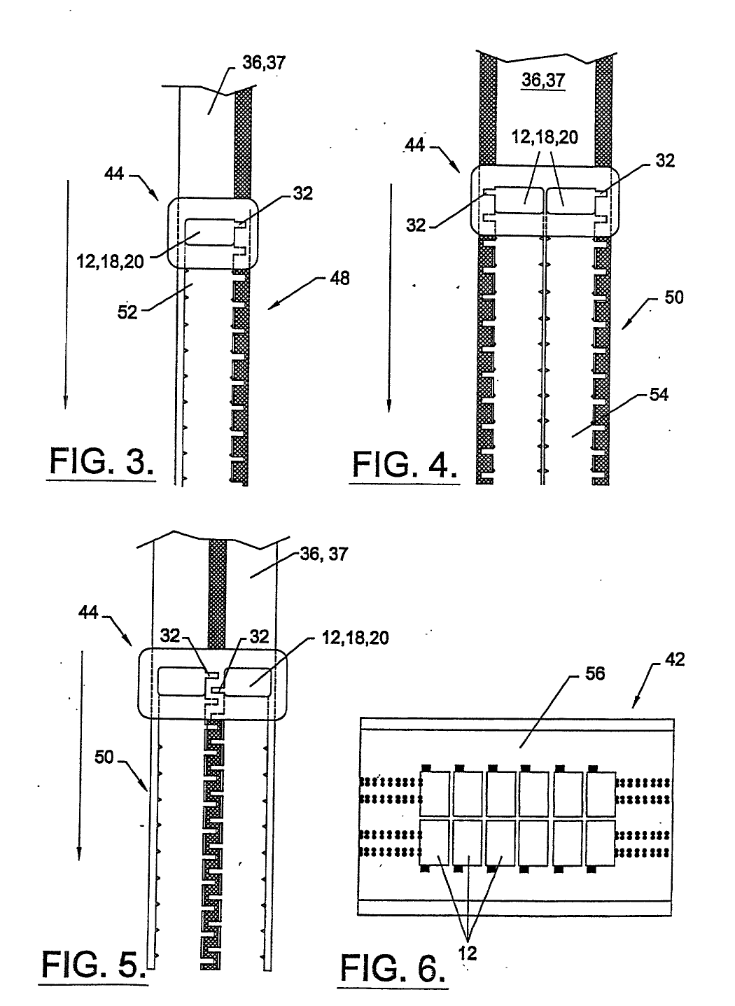

As illustrated by way of example with reference to FIGS. 3 and 4, the electrodes, the anode 12, or the cathodes 18, 20, can be produced in a single stream 48 or optically in a double (2 up) stream 50 depending on machine speed and thus throughput requirements. FIG. 3 illustrates a typical “one up” die punch pattern 52 with no scrap between the electrodes. FIG. 4 illustrates a typical “two up” die punch pattern with tabs 32 outwardly facing, while FIG. 5 shows a “two up” pattern with tabs 32 inwardly facing. One embodiment of the present invention includes the electrode 12 being punched out on three sides only with the index distance of the web between punches being shorter then the width of the male 47/female 49 die punch tooling. This provides for a minimized scrap discharge, reducing materials consumption and cost, while maintaining desired dimensional tolerances. Typically, a die punch may be such that metallic filaments (Cu, Al) within the coating 13, 19, 21 of the electrodes (12, 18, 20) can be stretched and bent over edge portions of the coating, thus creating burrs. These burrs can immediately short out the battery, or eventually cause the battery to fail. Burr free die punching is desired in order to have an economically and technically viable manufacturing process, one object of the present invention. The die punch utilized in the embodiment herein described for the present invention is based on “zero clearance” male and female punch die parts that have been machined, hardened, wire electro-discharge-machined (EDM'd) and ground with standard industrial processes to produce the minimum clearance between the male and female parts, typically in the 0.0001 to 0.0002” range.

In addition to the male 47/female 49 die punch parts having close tolerance, a “zero clearance” stripper plate 45 is included. The function of the stripper plate 45 is to clamp the web materials tightly prior to the male tool die closing against the web and cutting it thru the female die 49. By way of example, as the copper metal tends to be ductile, clearance between the clamping area and the female die can allow the filaments to stretch during the cut, again creating burrs. The present invention improves on known tooling efforts by using the zero clearance stripper plate 45 formed from brass. The openings in the stripper are machined (EDM'd) slightly undersize of the male die punch dimensions. As will be later detailed, when assembled, the male die punch cuts thru the brass plate for forming a true zero clearance fitup. The embodiment herein described, by way of example, provides clean cutting and a long duration of burr free operation and improves on known methods employing coated expanded metal materials.

The application of a vacuum conveying system to the electrode web material handling and electrodes further improves manufacturing capability. Past efforts to accurately feed web material thru a mechanical process have been hampered by the inherent mechanical and physical characteristics of the web, including, by way of example, lack of stiffness and lack of beam strength, it can be stretched and distorted when pulled under tension, and it can be compressed with clamping devices. As a cut to size electrode is extremely light and fragile, typical mechanical transport methods are difficult to apply. The vacuum conveyor 42 of the present invention accurately tracks the web 36 into and thru the die punch assembly 44, regardless of web wrinkles, width variation and coating thickness variation, and also accurately delivers cut to size electrodes (anode or cathodes) as herein described. Fixturing is provided on tightly controlled centerlines to accomplish a desired electrode to electrode registration.

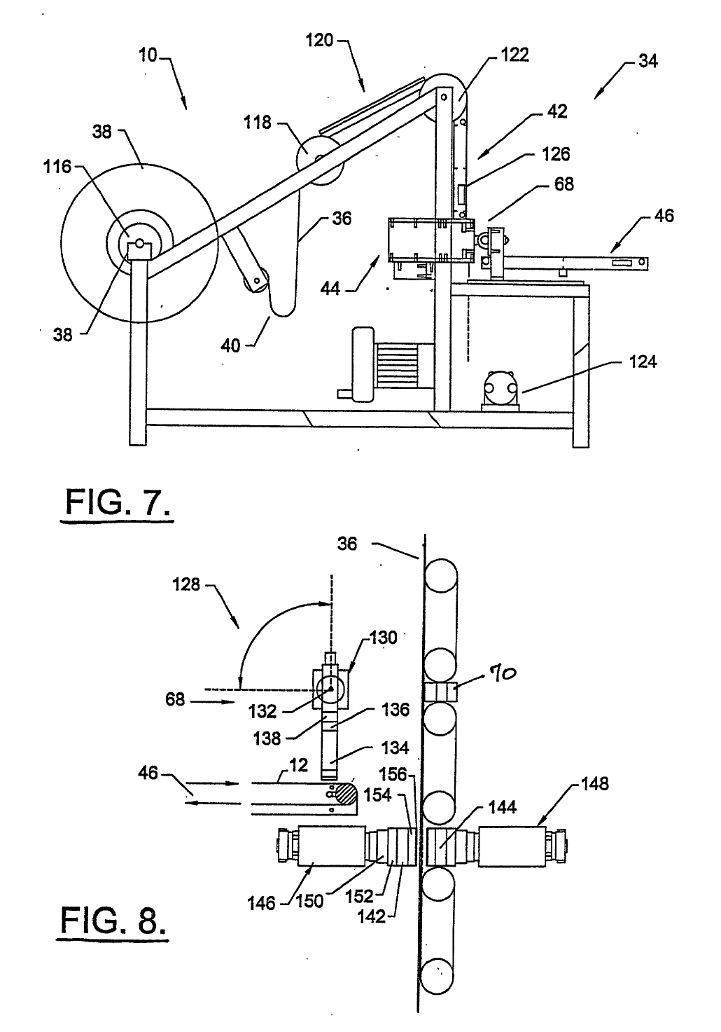

By way of example, FIG. 6 illustrates one discharge pattern 56 of electrodes, anodes 12 by way of example, after placement on the servo driven vacuum indexing conveyor 46. Depending on the desired apparatus 10 configuration, the electrodes 12 can be separated into groups as earlier described with reference to FIGS. 4 and 5. By way of example, two-up die punching at 75 cycles per minute produces 150 electrodes per minute, but placement of a group of 6 electrodes to the separator web then can occur at 25 cycles per minute allowing enough dwell time for the fixturing process.

With reference again to FIGS. 1 and 1A, the separator webs 14, 16 of a coated mylar film are provided from rolls 58, 60 and indexed thru a fixturing and lamination station 62 with additional, yet optional, servo vacuum indexing conveyors 64, 66 or, alternatively, a servo pneumatic clamping drawoff system. The electrode 12 or pattern of electrodes are transferred from the discharge area of the electrode vacuum conveyor 46 by means of a hot vacuum chuck pick and place mechanism 68, and pressed against the first separator web 14 at an anvil 70. The electrode 12 is typically very thin, and materials of its construction typically highly thermally conductive and, as a result, it rapidly heats up but shows no tendency to become tacky or sticky, or deform at an elevated temperature. When pressed against the first separator web 14 (which is at ambient or slightly elevated from ambient temperature), it quickly energizes the surface of the separator coating and “tacks” to it. When the heated transfer head of the pick and place mechanism 68 returns, the electrode 12 remains fixtured to the first separator web 14. This process improves on known processes, as no additional materials are needed, and no thermal distortion of the web 14 or electrode 12 occurs. The second separator web 16 is then introduced, now sandwiching the anode12 between the webs 14, 16. As indexed vertically downward, the webs 14, 16, enter the lamination station 62. The lamination station 62 allows the webs 14, 16 to be flat platen laminated a plurality of times to insure a complete and uniform lamination of the separator webs 14, 16 to the anode 12, in a relatively short time (which time dictates machine throughput capability) and at a relatively low temperature.

As will be described in further detail later in this section, the lamination station 62 of the embodiment herein described by way of example includes a heated transfer plate with controlled electric heating means, a chill plate to tie temperature boundary conditions to attain thermal uniformity, adjustable and programmable platen pressure provided through pneumatic cylinders, conformable platens, lamination platens with release characteristics. By laminating the webs 14, 16 in the vertical path, substantial improvements in release of the web from the lamination platens zero tension distortion of the heated web, and repeatable web tracking thru the lamination station is attached.

At this stage of the manufacturing process, the laminated anode/separator web combination 22, as earlier described with reference to FIG. 2, progresses into a free loop 72, then on to a cathode assembly while cooling. There is no tension on the combination web 22 at this point, and it is supported by the mylar release films 15, 17 which extend to cover, confine and support the extended bare metal tab 32 earlier described with reference to FIG. 4.

With reference again to FIGS. 1 and 1B, the combination web 22 then enters a cathode assembly section 74 of the apparatus 10. The mylar release film 15, 17 is removed from the combination web 22 prior to cathode assembly using guide and stripping rollers 75 and mylar rewind spindles 76. As the web 22 has been thru a thermal excursion and the free loop 72, the anode laminate, separator anode combination 22 is precisely registered for guidance into the cathode assembly station 74. Use of a laser photo-optical device 78 to read the position of the anode 12 and a typical feedback loop to the index mechanism accomplish registration for each group of anodes. With continued reference to FIGS. 1 and 1B, the cathode assembly section 74 includes two cathode preparation modules 80, 82 which present electrodes 18, 20 at two transfer points 84, 86 at the same time, having been formed from cathode webs 37. Heated vacuum pick and place chucks 88, 90 then engage both sets of cathodes 18, 20, heat them during the transfer as earlier described with reference to FIG. 1A for the anode preparation module 34 and press them onto the anode/separator web 22.

Adjustable differential pressure is used on the placement heads such that one head extends to a precision stop at the web surface, while the other head presses with lower (adjustable) fixturing pressure.

Following the picking and placing of the cathodes 18, 20 onto the web 22, mylar release films 92, 94 are introduced on both sides of the now assembled web identified by numeral 96, prior to final lamination. This addition of mylar film material prevents exposed separator material from sticking to the lamination platens while covering, confining, and supporting the bare metal tabs 28, 30, 32 described earlier with reference to FIGS. 2-5.

The assembled and covered web identified by numeral 98 then enters a second lamination station 100 where the cathodes 18, 20 are fully laminated to the separators 14, 16, again optionally over multiple indices using vacuum indexing conveyors 65, 67. The multiple lamination steps within each of the lamination stations 62, 100 herein described by way of example, provide a substantial improvement over known configurations and provides for a full and uniform lamination with all desired process parameters controlled, and monitored. The lamination stations 62, 100 allow for desirable low temperatures at shortest dwell times when compared to those achievable in the art.

After lamination at the lamination station 100, the mylar film 94 is stripped from the assembled web 98 and rewound onto a rewind spindle 102. The web now identified by numeral 104 enters a free loop 106 while cooling, and is engaged by a final servo driven vacuum indexing conveyor 108, as illustrated with reference again to FIGS. 1 and 1C. Another laser photo-optical device 79 registers the web 104 into the cutting station 110, so that cutters can slice cell electrode groups apart along separator center lines. A slitting knife 111 disposed in the vertical axis cuts the web 108 along the direction of travel thereof, and one or multiple rotary knives crosscut the web for forming battery cells 24 once indexed into the cutting station 110. A vacuum head pick and place mechanism 112 transfers the cut cells 24 onto a discharge vacuum conveyor 114.

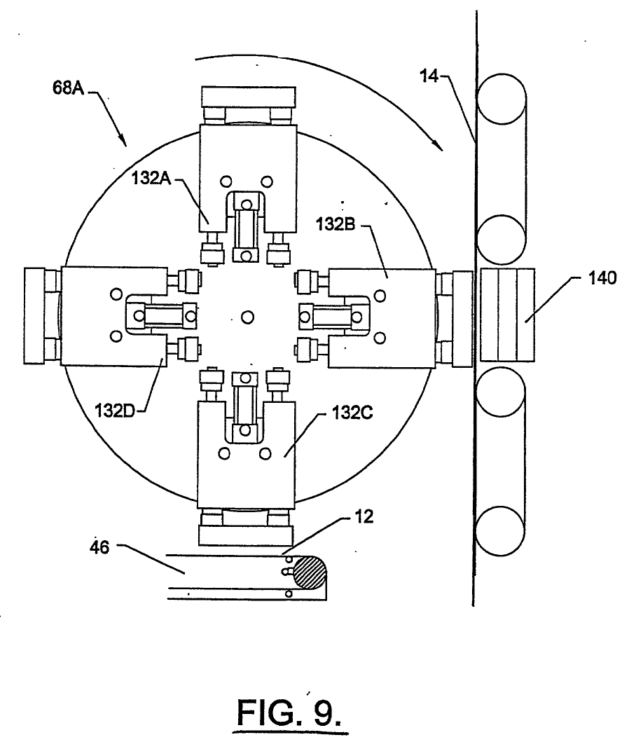

With reference to FIG. 7, one embodiment of the present invention includes electrode preparation module 34 having powered spindle116 upon which to mount the roll 38 of coated electrode material. The spindle 116 is actuated as material is drawn thru the apparatus 10 with high/low optical sensors into the loop 40 as earlier described with reference to FIG. 1. The web 36 of the anode 12 runs up over a roller 118 onto an adjustable flat guide 120, then down over a roller 122. The web 36 is held flat against the servo powered conveyor 42 by means of negative pressure created by a blower 124 pulling air thru the conveyor 42 for causing a vacuum which holds the web 36 flat against a belt, and secures it firmly during indexing so as to generally eliminate slippage. The web 36 then enters the die punch 44, where a motor or cylinder powers a die punch tool. Cut to size electrodes are held by the vacuum pick and place head 68 operated by vacuum pump. As earlier described with reference to FIG. 1, the pick and place head 68 transfers the die cut electrodes 12 to the electrode vacuum discharge conveyor 46. This conveyor 46 indexes the electrodes downstream to the transfer position for continued assembly of a battery cell.

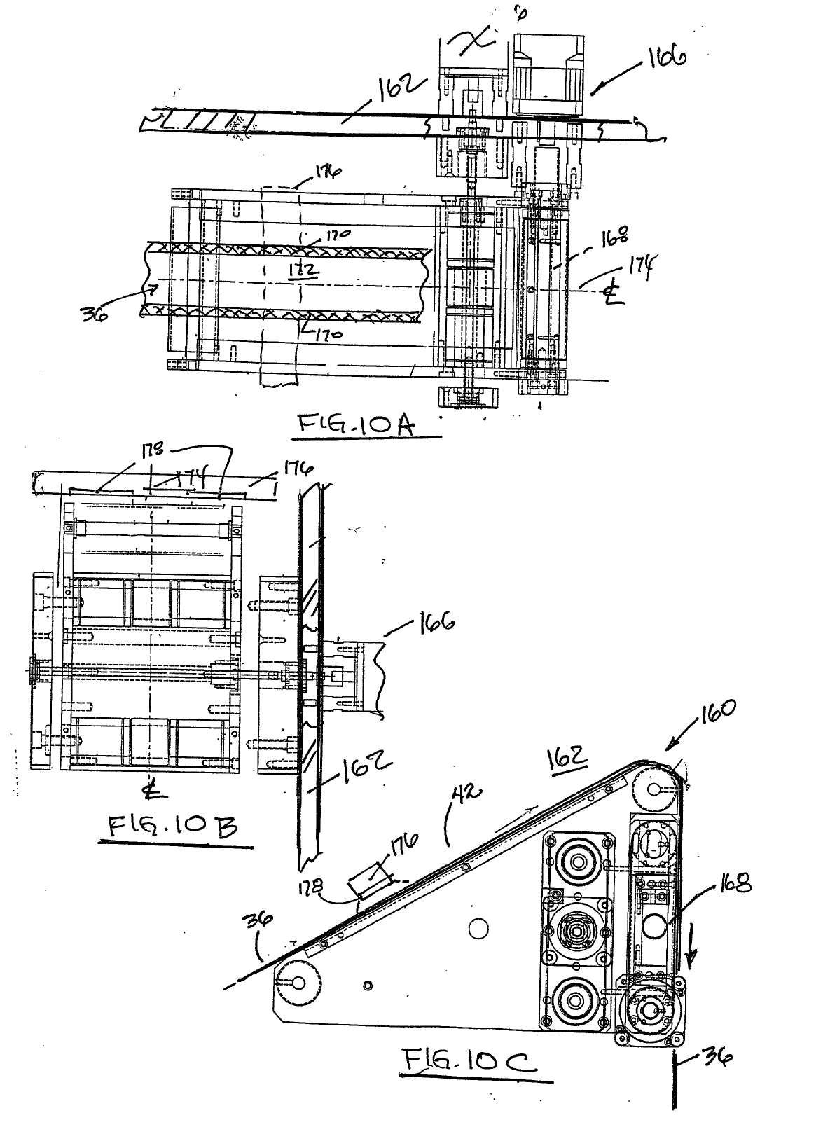

Depending on the desired system configuration reciprocating or continuous indexing transfer pick and place mechanisms 68 are employed. As illustrated, by way of example, with reference to FIG. 8, a reciprocating version of a heated vacuum transfer 128 includes a rotary drive 130 which swings the transfer mechanism back and forth thru a 90 degree arc. A pneumatic slide 132 extends and retracts the temperature controlled head 134 attached to the slide by means of a phenolic or other insulation material heat dam 136, and chilled tool plate 138. The transfer vacuum head 134 has a plurality of holes to engage the flat electrode 12 via a vacuum for removing it from the conveyor 46.

After moving thru 90 degree arc, the electrode 12 is hot (generally above room temperature), and the slide 132 extends to press the heated electrode 12 onto the vertically disposed separator/mylar web 36 supported by anvil 70. The vacuum head retracts, leaving the electrode 12 stuck (but not laminated) to the separator 14, as earlier described. The fixtured electrode and separator web 22 indexes thru the vacuum conveyor 64 or clamping drawoff as earlier described with reference to FIG. 1.

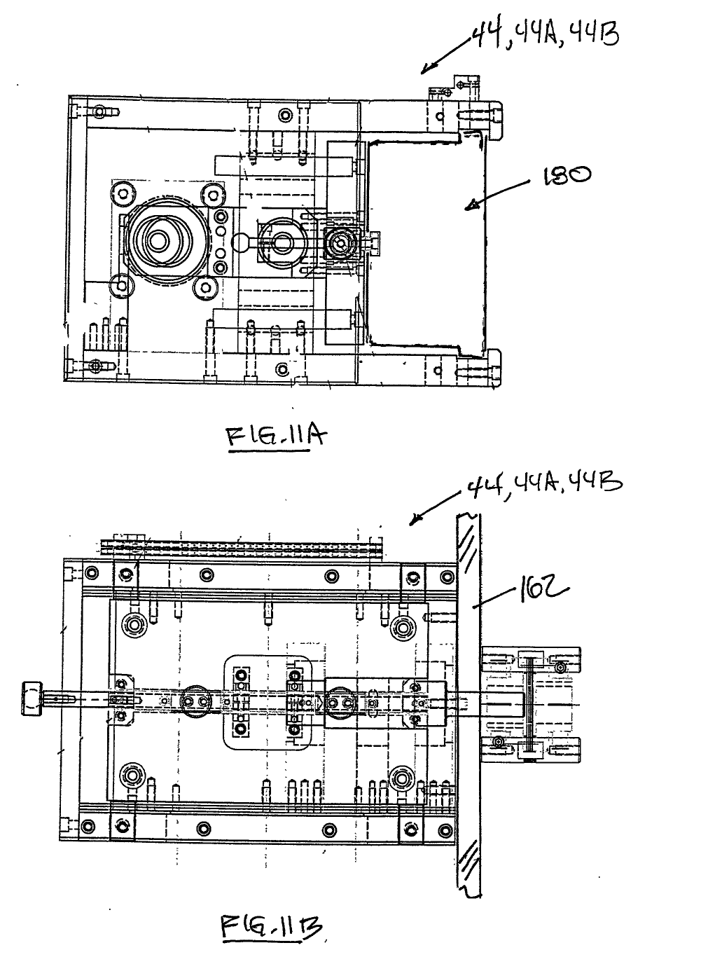

As illustrated with reference to FIG. 9, one embodiment of the heated transfer pick and place mechanism 68 provides for continuous high speed operation (e.g.; 240 parts per minute and up). As time intervals between index advancing become short especially during high cyclic rates, a turret styled embodiment of mechanism 68A permits time to heat the electrodes 12 sufficiently during intermediate cycles as it rotates clockwise, as herein described, by way of example, to get the electrodes to “tack” successfully to the separator web 14 which is supported by anvil 140. The indexing turret mechanism 68A is cam driven through 90 degree arcs indexing at four positions and includes four pneumatic slides 132A-D. Each slide 132 includes similar heated vacuum heads as earlier described.

With reference again to FIG. 8, one embodiment of the lamination station 62, 100, earlier described with reference to FIG. 1, includes two independently temperature controlled platens 142, 144 mounted to ram driven presses 146, 148. Depending on a desired apparatus embodiment, one or both platens will cycle for each index of the web 36, with both platens will retract fully open during machine pauses or changeovers. Chill plates150 on each press 146, 148 interface to the presses to stop thermal migration into the lamination elements and provide a boundary condition for the heat plate 142, 144 to assist in providing temperature uniformity. A heat dam (insulator) plate 152 isolates the heat plate 142, 144 from the chill plate 150 to minimize heat energy migrating into the apparatus 10 and to provide temperature uniformity. Heater plates 154 contain electrical heaters and temperature measuring (thermocouple/RTD) devices. Lamination platens 156 utilize thermally conductive metallic backing with elastomeric coating which conforms to the electrodes being laminated to generate uniform lamination pressures and temperatures over all the cells.

The apparatus 10 above-described with reference to FIGS. 1A-1C will herein be described in further detail. The anode preparation module 34 includes a web feed system having the web 36 of coated copper grid material fed from the roll 38 of anode web material into a loop 158, then vertically down the servo driven vacuum indexing conveyor 42 into the die punch assembly 44. As earlier described, the vertical configuration of the copper grid web 30 improves web tracking accuracy and stability, as well as feed advance (indexing) accuracy. There are no gravitational forces acting on horizontal web material to create droop or index to index length variations. With web material typically locking in firmness and thus susceptible to tension distortion, vertically suspending the web 36 permits gravity to hold a desirable smooth shape of the web, which is otherwise difficult when conveyed and processed in horizontal positions, as typically done in the art.

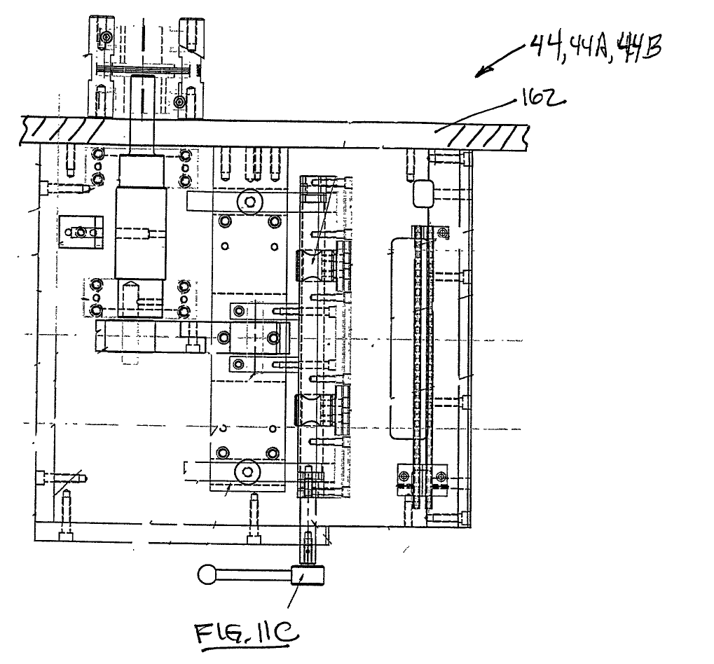

As earlier described with reference to the known prior art, it is known that there is substantial difficulty with manufacturing of electrode materials to high tolerances required for the width and tracking of the chemical coating of anode metal mesh relative to the edges of the metal mesh. By way of example, mistracking or width variation will either cover the tab 32 (see FIG. 4) with opaque electrode coating or not cover enough of the mesh to provide for the desired battery cell performance. With reference again to FIG. 1A, to overcome such known alignment problems, the present invention incorporates an automated edge guide controller (EGC) 160. The vacuum indexing conveyor 42 and its associated flat guide are mounted to a linear bearing wall 162 carried by a frame 164 of the apparatus 10. The controller 160 is operated for advancing the web 36 downstream to the cutting area of the die punch 44 by a servo motor and ballscrew assembly 166 illustrated with reference to FIGS. 10A-10C. Beam photo optical digital sensors 168 see through the open mesh 170 of the anode web 36 and are triggered by the opaque electrode coating 172. Electronic feedback loops drive the servo motor assembly 166 to position the web 22 between the sensors, keeping the coating along a centerline 174 centered relative to the die punch assembly 44.

In an alternate embodiment, a vision system 176 is used on one side of the web or on both sides of the web. The vision system 176 views not only the expanded metal mesh, but perforated and opaque foils as well. A camera 178 within the vision system 176 tracks the width of the coating 172 as well as its position relative to the edge of the metal mesh 170 or foil, and the servo assembly 166 uses information therefrom to track the web 36. In addition, the vision system 176 scans for other materials defects, such as bare spots (missing coating), web splices, by way of example, and allows the apparatus 10 to skip over that section of the material, and then resume normal operation. The amount of undesirable product is reduced, and apparatus downtime and operator intervention time required is also reduced.

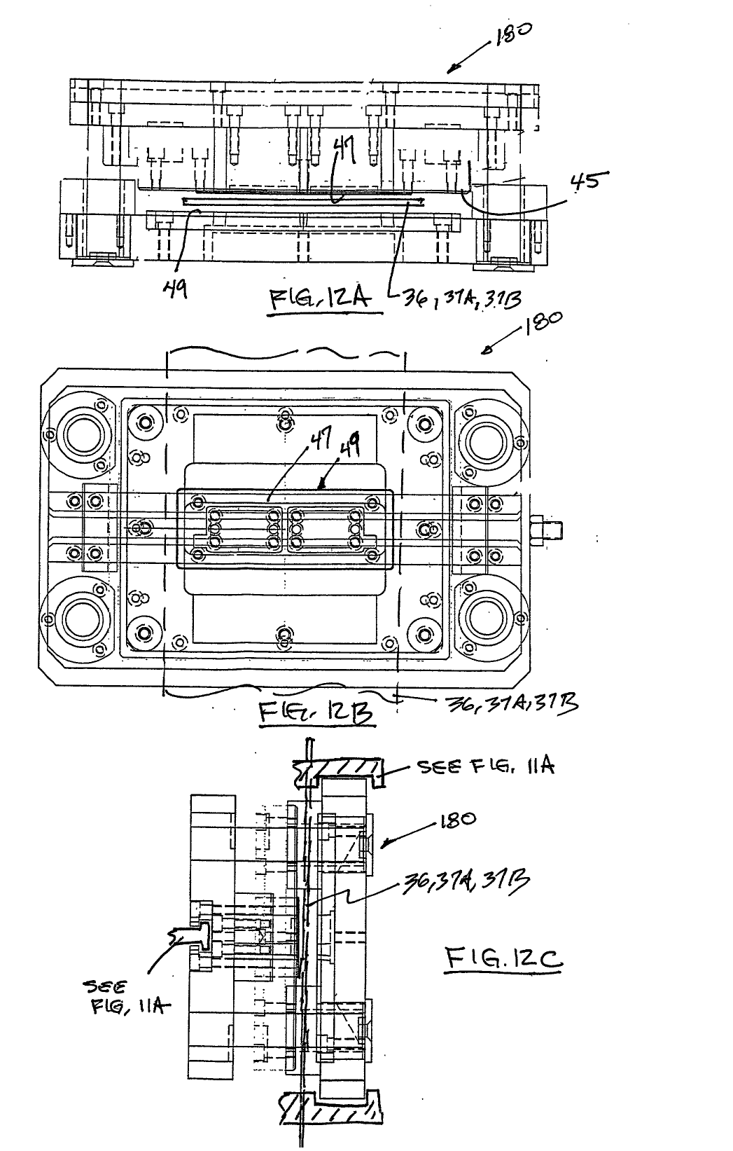

As earlier described with reference to FIGS. 1, 1A, 1B, 11A, 11B, and 11C, the die punch assembly 44 operates to form the electrodes 12, 18, 20. By way of example, a cathode die punch 180 is illustrated with reference to FIGS. 12A, 12B, and 12C. Except for the shape and layout, the anode and cathode punch are similar. The die punch 180 engages the web 36 (cathode web) with the stripper plate 45 to clamp the web firmly and flatly in position. The male tool die 47 punches through the web 36 producing a desired electrode shape which electrode is then held by a vacuum chuck and transferred using the pick and place mechanism 68 from the die punch assembly 44 to the horizontal servo driven vacuum indexing conveyor 46.

As earlier described, electrodes (anode and cathode) can be produced in a single stream or a double (2 up) stream depending on the desired machine speed and throughput requirements.

In operation, one method of manufacturing includes the electrodes being punched out on three sides only where the index distance of the web between punches is shorter then the width of the male or female die punch tooling. This allows a minimized scrap discharge reducing materials consumption and cost, yet maintains dimensional tolerances.

The die punch assembly 44 and die punch 180 operated therewith provides a “zero clearance” male and female punch and uses die parts that have been machined, hardened, wire electro discharge machined (EDM'd) and ground with standard industrial processes to produce the minimum clearance between the male and female parts, typically in the 0.0001″ to 0.0002″ range. In addition to the male/female die elements having close tolerance, the present invention incorporates a “zero clearance” stripper plate 45. The function of the stripper plate 45 is to clamp the web 36 tightly prior to the male die 47 closing against the web 36 and cutting it through the female die 49. As the copper metal tends to be ductile, any clearance between the clamping area and the female die 49 may allow the grid metal filament to stretch during cutting and form burrs.

In one embodiment of the punch assembly, the openings in the stripper plate 45 are wire EDM'd slightly undersize of the male die 47 dimensions. When assembled, the male die 47 cuts through the brass, forming a true zero clearance fitup. The cleanest cutting and longest duration of burr free operation is assured and improves upon any method tested to date with the coated expanded metal materials.

By way of example or operation, variations on materials characteristics extend to surface “tackiness”, and sticking of the web 36 to the die punch 180 including the stripper plate 45. To avoid this, floatation air streams are used that are closely directed at the stripper plate 45 to web interface, as well as the web to female die interface. In addition, surface treatment techniques such as glass beading, and release coatings, such as electroless nickel may be employed.

The apparatus 10 herein described with reference to FIGS. 1A-1C, employs a vacuum conveying system for the electrode web material handling and electrodes which enhances the manufacturing process. Typical efforts to accurately feed the web material by means of a mechanical process have been hampered by inherent mechanical and physical characteristics of web material. Typically web material has no stiffness, no beam strength, can be stretched and distorted when pulled under tension, and can be compressed with clamping devices. As the cut to size electrode is extremely light and fragile, typical mechanical transport methods are difficult to apply. The vacuum conveying system accurately tracks the web into and through the die punch tool, regardless of web wrinkles, width variation and coating thickness variation, and also accurately delivers the cut to size parts to fixturing stations on tightly controlled centerlines to accomplish a desired electrode to electrode registration.

With reference again to FIG. 6 one discharge pattern of discrete electrodes after placement on the servo driven vacuum indexing conveyor 46 is illustrated. Depending on a desired configuration, the electrodes can be separated into groups, e.g., two - up die punching at 75 cycles per minute produces 150 electrodes per minute, but placement of a group of 6 electrodes to the separator web then can occur at 25 cycles per minute allowing enough dwell time for the fixturing process, as earlier described. The scrap anode web 30 is pulled downward by gravity or optionally by a vacuum device 39A.

The separator web 14 is introduced from the roll 58 and indexed through fixturing and the lamination station 62 with the additional servo vacuum indexing conveyors 64, 66 as earlier described with reference to FIG. 1A. The electrode or pattern of electrodes are transferred from the discharge area of the die punch assembly 180 by the hot vacuum chuck pick and place mechanism 68, and pressed against the separator 16 at the anvil 70 of a heated platform 184. The electrode, as it is very thin, and the materials of its construction highly thermally conductive, rapidly heats up but shows no tendency to become tacky or sticky, or deform at elevated temperature. When the electrode is pressed against the separator web 16 (which is at ambient or slightly elevated from ambient temperature), it quickly energizes the surface of the separator web 16 and “tacks” to it. When the heated transfer head returns to a spaced position to the separated web, the electrode remains fixtured to the separator web 16.

The separator web 14 is then introduced, now sandwiching the electrode (anode) between the two separator webs 14, 16. The sandwiched electrode web combination, illustrated by numeral 72 is advanced downstream through a loop 182 and to the vacuum indexing conveyor 66, as illustrated with reference again to FIG. 1A.

As illustrated with reference again to FIG. 1A, the separator web 16 is unwound from roll 60 and runs up and over the heated platform 184 underneath the electrode die punch pick and place mechanism 68. As the separator web 16 heats, its surface becomes “tacky.” When the electrodes are removed from the die punch assembly 44 and applied to the heated separator web 16, they remain fixtured thereto. Separator web tension is maintained in this application with an understanding that the mylar carrier shrinks under heat. This tension is maintained through the use of a dancer arm tension control 186 operable with the powered separator roll 60 in conjunction with the vacuum indexing discharge conveyor 46. In such an embodiment, a heated pick and place station may not be employed. The other separator web 14 is introduced, again with a dancer tension control 187 system and the powered unwind roll 58. The composite web of fixtured anodes to the first separator and the second separator flows through a drawoff system, including the loop 182, and to the lamination station 62.

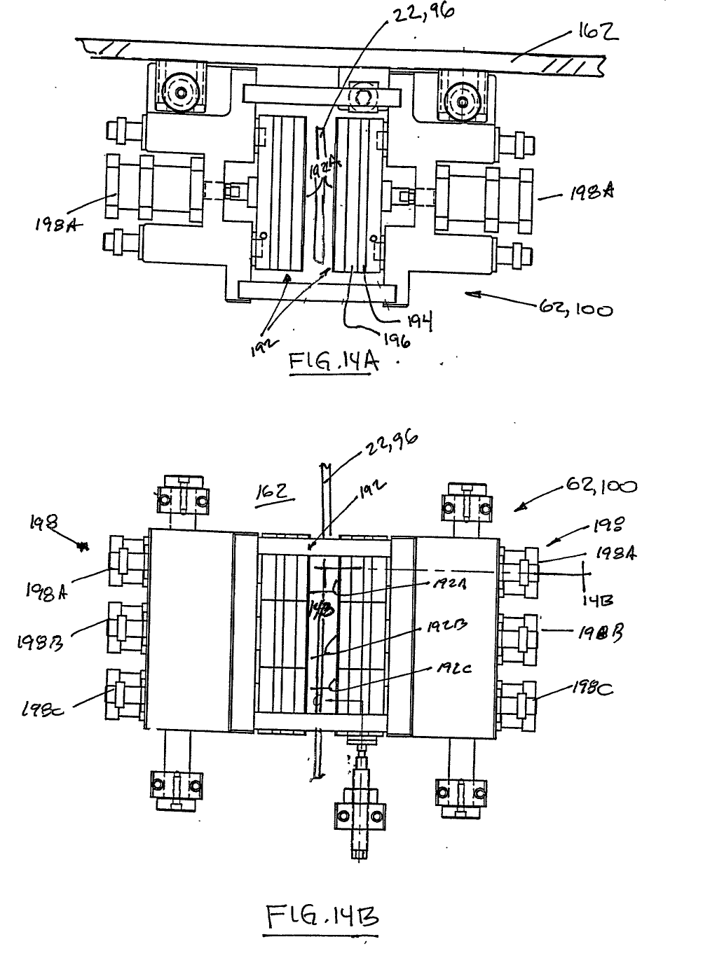

With reference again to FIG. 1A, a heated cross seal bar 168 is displaced above the first separator web 16/anode/second separator web 14 while horizontal leading onto the electrode discharge conveyor 46. The cross seal bar 188 seals the first separator web 16 to the second separator web 14 along locations 190 between the discrete anodes as illustrated with reference to FIG. 13A. This seal serves to secure the electrodes in place until they are fully laminated at the lamination station 62. The electrodes maintain their centerline location and skewness with this process insuring reliable registration downstream.

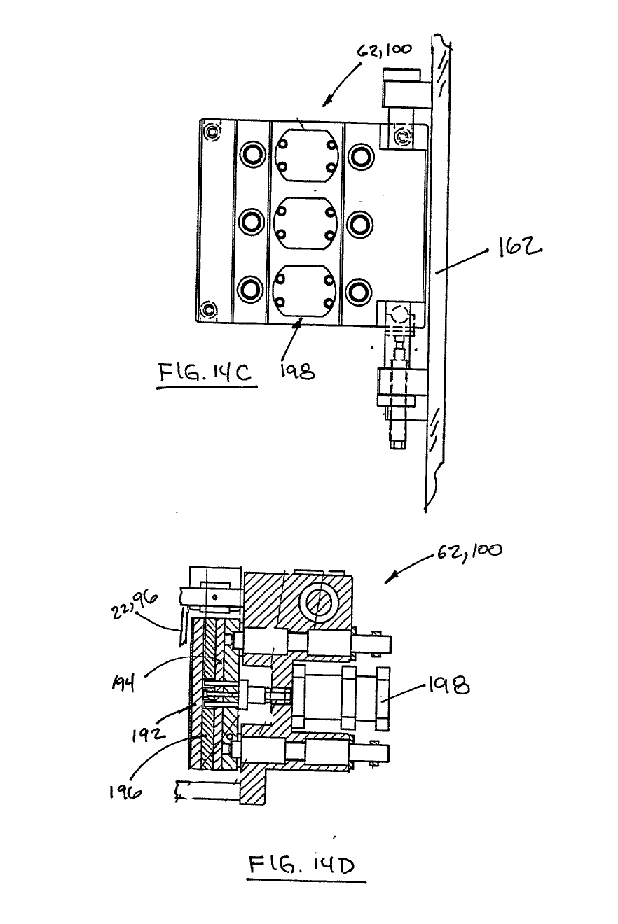

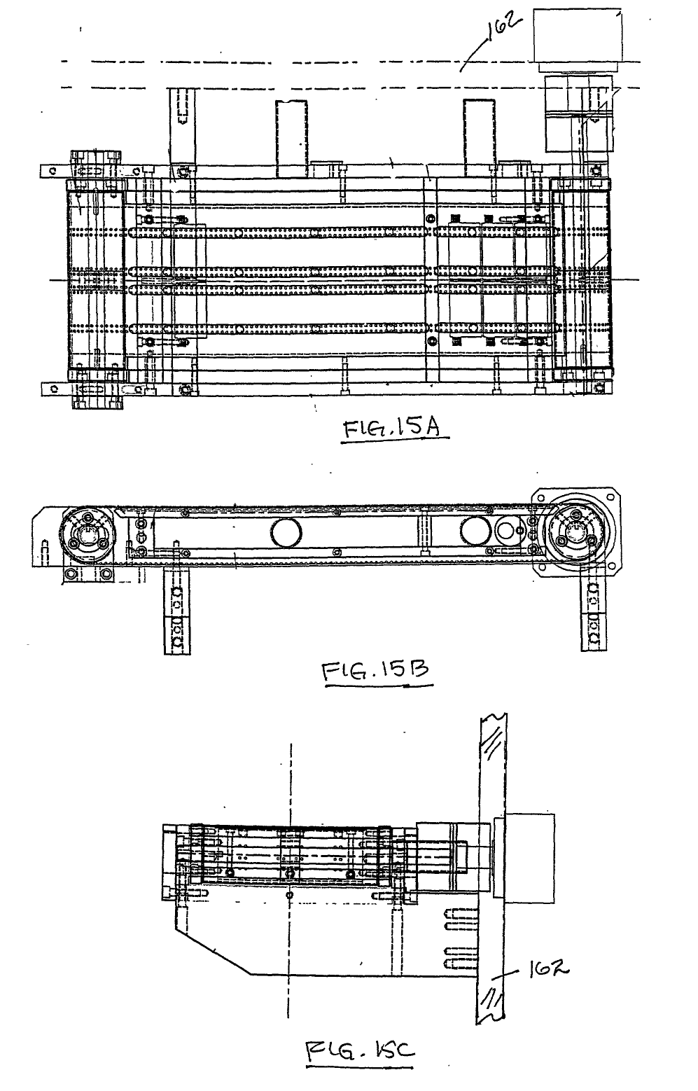

With reference again to FIG. 1A, the anode lamination station 62, the first lamination process within the apparatus 10 herein described, allows the web 22 to be flat platen laminated three times over three indexes for providing a uniform lamination of the separator webs 14, 16 to the anode in a preferably short time, which provides for improved machine throughput capability and at desirably low temperatures. With reference to FIGS. 14A-14D, each lamination station 62, 100 includes a heated transfer plate 192 with controlled electric heating means, a chill plate 194 operable with a heat dam 196 positioned between the chill plate 194 and transfer plate 192 to attain thermal uniformity at element boundaries. Adjustable and programmable platen pressure is provided via pneumatic cylinders 198. Conformable platens with release characteristics are provided by the transfer plate. With lamination operable in a vertical attitude, as earlier described, a substantial improvement is realized in release of the web 22 from the lamination platens 192, with zero tension distortion of the heated web, and repeatable web tracking through the lamination station. The lamination station 100 for the web 96 described earlier with reference to FIG. 1B is similar to that herein described for the lamination station 62.

The present invention provides a capability for properly laminating across a wide variety of materials. Lamination processing for the present invention includes multiple lamination sectors. By way of example, three separate pairs of plates 192 with three individual press ram cylinders198 are herein described. By way of example, each plate 192A, 192B, 192C is operable to laminate one array of electrodes (one index distance in the case of cellphone size batteries) or one large format (notebook/laptop) size battery. Each of the three lamination sectors 192A, 192B, 192C has individual pressure control, pressure measurement and display to allow pressure monitoring in each lamination sub-station, and individual temperature control of each pair of plates. This “three hit” feature allows for a wide variety of lamination parameters, and maintains throughput at desirable manufacturing rates.

It is known in the art that the formation of gas bubbles can be observed during the lamination process. Such is the case for the battery cell materials typically being laminated, and for the release of evaporables under applied heat. Elimination of the gas bubble formation is desired, as voids in the laminated web 22, 96 allow potential deposits of lithium metal to form, resulting in detrimental consequences to the battery performance and safety. By way of example, the embodiment of the present invention herein described includes the chill plate 194C operable in the third lamination sector 192C which removed any evidence of bubble formation in the lamination process described herein. In addition, the lamination process can be varied by using different styled lamination plates 192 such as conformable plates. By way of example, using one conformable plate 192 opposed by one hard flat plate has produced substantially improved results in lamination uniformity over a large area, a requirement for large area battery (notebook/laptop) styles. The present invention is not limited to three sectors as herein described by way of example, and it is expected that the number of sectors used will be expanded or reduced as necessary to address specific applications.

At this stage of the manufacturing process, the now laminated anode and separator webs, the web 22 advances into the free loop 72, then toward the cathode assembly. There is minimal tension on the web 22 at this point, and it is supported by the mylar release film which extends to cover, confine and support the extended bare metal tab 32, as earlier described and as illustrated with reference to the partial enlarged cross-section view of FIG. 13.

The web 22 then enters the cathode assembly section 74 of the apparatus, as illustrated again with reference to FIG. 1B. The mylar release film (or paper liner if employed) is removed from the web 22 prior to cathode assembly. The guide rollers 75 and rewind spindles 76 earlier described perform this function. As the web 22 has been through a thermal excursion and the free loop 72, the anode laminate is now desirably and precisely registered into the cathode assembly section 74 using the laser photo-optical device 78 to read the position of the anode and provide a feedback loop to the index mechanism 65, 67 provide registration for each group of anodes.

The cathode preparation modules 80, 82, earlier described with reference to FIG. 1, present electrodes to two transfer points 84, 86 at the same time, as illustrated with reference to FIG. 1B. The heated vacuum chucks 88, 90, including vacuum conveyor 65 with edge guides, then engage both sets of cathodes, heat them during the transfer as earlier described, and press them onto the anode/separator web 96. Adjustable differential pressure is used on placement heads such that one head extends to a precision stop at the web surface, while the other head presses with lower (adjustable) fixturing pressure. Subsequent to this cathode assembly step, the mylar release films 92, 94 are introduced (or in the alternative, paper release liner) on both sides of the assembled web 98, and prior to final lamination at the lamination station 100. The mylar release film prevents the exposed separator material from sticking to the lamination platens and serves to cover, confine, and support the bare metal tabs. The assembled and covered web 98 then enters the second platen lamination station 100. The cathodes are fully laminated to the separators over three sectors or indexes as earlier described. Again, the three lamination step (three hit) within each laminator configuration provides full and uniform lamination with process parameters controlled and monitored, with desirable temperatures at short dwell times.

After lamination, the upper mylar film 94 is stripped from the assembled web 98 and rewound onto the rewind spindle 102. The web 104 results and is illustrated in the partial enlarged cross-section view of FIG. 13A.

As illustrated with reference to FIG. 1C, the web 104 advances downstream and enters the third free loop 106 and is then engaged by the final servo driven vacuum indexing conveyor 108. A laser photo-optical device registers the web into the cutting station 110, so that the cutters 111 can slice the cell group and separate them on the separator centerline. One embodiment of the present invention as herein described includes a slitting knife 111 carried in the vertical axis for cutting the web 104 along the direction of travel, and one or multiple rotary knives crosscut the cells once indexed into the cutting station. The vacuum head pick and place mechanism 112 transfers the discrete cells onto the discharge conveyor 114, a vacuum conveyor as herein illustrated by way of example. Prior to cutting, the remaining mylar film 92 is removed and collected on a rewind roll 200.

In one preferred embodiment of the present invention, the “three hit” lamination module is used as above-described with reference to FIGS. 14A-14D. As described, there is similar construction for each lamination substation in the module, with individual temperature control, pressure controls and monitors, and selectable lamination plates that can be 50, 60, 70 durometer coatings (by way of example) as well as Teflon Hardcoat aluminum. Substations are setup as heated modules or chilled modules, depending on the desired lamination process for the materials application.

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

That which is claimed is:

1. A method of manufacturing a battery cell comprising the steps of:
vertically suspending an anode material web;
forming a discrete anode from the anode material web;
juxtaposing the discrete anode between first and second separator webs;
vertically suspending the first and second separator webs for longitudinally extending the first and second separator webs by a force of gravity for smoothing out web surfaces adjacent the discrete anode carried therebetween;
laminating the first and second separator webs to the discrete anode for forming a laminated anode carried by the first and second separator webs;
vertically suspending a cathode material web;
forming first and second discrete cathodes from the cathode material web;
juxtaposing the first and second discrete cathodes at exposed outside surfaces of the vertically suspended first and second separator webs, wherein the first and second cathodes are in alignment with the laminated anode carried therebetween;
laminating the first and second discrete cathodes to the vertically suspended first and second separator webs for forming a laminated battery cell carried by the first and second separator webs; and
cutting the first and second separator webs for liberating a discrete battery cell therefrom.

2. The method according to claim 1, wherein the anode material web and cathode material web comprise coated copper grid material and coated aluminum grid material, respectively.

3. The method according to claim 1, further comprising the steps of:
providing an anode coil stock roll for carrying the anode material web thereon;
rotatably driving the anode coil stock roll for unwinding the anode material web therefrom;
feeding the anode material web to an anode web indexing conveyor for guiding the anode material web in the vertically suspending step; and
controlling tension within the anode material web between the anode coil stock roll and the anode web indexing conveyor.

4. The method according to claim 1, wherein the discrete anode and cathode forming steps each comprise the step of die punching the vertically suspended anode and cathode material webs, respectively.

5. The method according to claim 1, further comprising the steps of:
providing an anode horizontal support surface;
providing first and second carrier webs having the first and second separator webs carried thereon, respectively the first and second carrier webs stored on first and second separator coil stock rolls, respectively;
rotatably driving the first and second separator coil stock rolls for unwinding the first and second carrier webs and thus the first and second separator webs, respectively therefrom;
feeding the first carrier web onto the anode horizontal support surface, wherein the first carrier web is positioned between the anode horizontal support surface and the first separator web;
the discrete anode juxtaposing step including the step of picking the discrete anode from the anode material grid web and placing the discrete anode onto an exposed upwardly facing surface of the first separator web carried on the anode horizontal support surface; and
feeding the second carrier web onto the first carrier web carried on the anode horizontal support surface, wherein the second carrier web and the first carrier web carry the first and second separator webs and the discrete anode therebetween, for advancing to the first and second web laminating step.

6. The method according to claim 5, further comprising the step of controlling tension within the first and second separator webs between the anode support surface and the first and second separator coil stock rolls, respectively.

7. The method according to claim 5, further comprising the step of attaching the first separator web to the second separator web for fixing the discrete anode therebetween.

8. The method according to claim 5, further comprising the steps of:
removing the first and second carrier webs from the first and second separator webs for exposing outside surfaces of the first and second separator webs; and
rewinding the first and second carrier webs onto first and second carrier web rewind spools.

9. The method according to claim 1, further comprising the steps of:
providing first and second cathode material webs on first and second cathode coil stock roll;
rotatably driving the first and second cathode coil stock roll for unwinding the first and second cathode material webs, respectively therefrom;
feeding the first and second cathode material webs to first and second cathode material web indexing conveyors, respectively, for guiding the first and second cathode material webs into a vertical orientation for the cathode material web vertically suspending step.

10. The method according to claim 9, further comprising the step of controlling tension within the first and second cathode material web between the first and second cathode coil stock rolls and the first and second cathode web indexing conveyors, respectively.

11. The method according to claim 9, further comprising the steps of:
providing first and second cathode horizontal conveying surfaces;
picking the first and second discrete cathodes from the vertically suspended, first and second cathode material webs and placing the first and second discrete cathodes onto the first and second cathode horizontal conveying surfaces, respectively; and
horizontally conveying the first and second discrete cathodes for placing the first and second discrete cathodes proximate the exposed surfaces of the first and second, vertically suspended separator webs, respectively, and wherein the first and second discrete cathodes juxtaposing step includes the steps of picking the first and second discrete cathodes from the first and second cathode horizontal conveying surfaces, respectively, and placing the first and second discrete cathodes onto the exposed vertically suspended surfaces of the first and second separator webs.

12. The method according to claim 11, wherein the first and second cathode horizontal conveying surfaces each include a vacuum indexing conveyor for incrementally advancing the first and second discrete cathodes downstream.

13. The method according to claim 1, further comprising the step of heating the first and second discrete cathodes sufficiently for adhering to the exposed surfaces of the first and second separator webs, respectively.

14. The method according to claim 9, further comprising the steps of:
unwinding third and fourth carrier webs for vertically carrying the first and second discrete cathodes, first and second separators, and laminated anode juxtaposed combination therebetween prior to the first and second discrete laminating step; and
rewinding the third and fourth carrier webs onto third and fourth carrier web rewind spools for removing the third and fourth carrier webs from the vertically suspended laminated battery cell carried by the first and second separator webs prior to the cutting step.

15. The method according to claim 1, further comprising the steps of:
picking the discrete laminated battery cell from the vertically suspended first and second separator webs;
placing the discrete battery cell onto a discharge conveyor; and
conveying the discrete battery cell for use in manufacturing a battery.

16. The method according to claim 1, wherein the discrete anode forming step comprises the step of forming a pair of transversely opposing discrete anodes.

17. The method according to claim 1, wherein the discrete anode juxtaposing step comprises the step of heat sealing the first separator web to the second separator web along a line adjacent the discrete anode.

18. The method according to claim 1, wherein each of the laminating steps comprise the steps of:
laminating at a first preselected temperature and a first preselected pressure for a first preselected time period at one laminating position; and
laminating at a second preselected temperature and a second preselected pressure for a second preselected time period at a second laminating position downstream the first laminating position.

19. A method of manufacturing a battery cell comprising the steps of:
juxtaposing a discrete anode between first and second separator webs;
vertically suspending the first and second separator webs for longitudinally extending the first and second separator webs by a force of gravity for smoothing out web surfaces adjacent the discrete anode carried therebetween; and
laminating the first and second separator webs to the discrete anode for forming a laminated anode carried by the first and second separator webs.

20. The method according to claim 19, further comprising the step of attaching the first separator web to the second separator web for fixing the discrete anode therebetween prior to the laminating step.

21. The method according to claim 19, wherein the laminating step comprises the steps of:
laminating at a first preselected temperature and a first preselected pressure for a first preselected time period at a first laminating position; and
laminating at a second preselected temperature and a second preselected pressure for a second preselected time period at a second laminating position downstream the first laminating position.

22. The method according to claim 21, further comprising the steps of:
unwinding first and second carrier webs for vertically carrying the first and second discrete cathodes, first and second separators, and laminated anode juxtaposed combination therebetween prior to the first and second discrete laminating step; and
rewinding the first and second carrier webs onto rewind spools for removing the carrier webs from the vertically suspended laminated battery cell carried by the first and second separator webs prior to the cutting step.

23. The method according to claim 19, further comprising the steps of:
juxtaposing first and second discrete cathodes at exposed outside surfaces of the vertically suspended first and second separator webs, wherein the first and second discrete cathodes are in alignment with the laminated anode carried therebetween; and
laminating the first and second discrete cathodes to the vertically suspended first and second separator webs for forming a laminated battery cell carried by the first and second separator webs.

24. The method according to claim 23, further comprising the steps of:
unwinding first and second carrier webs for vertically carrying the first and second separator webs with the discrete therebetween prior to the first and second separator web to the discrete anode laminating step; and
rewinding the first and second carrier webs onto rewind spools for removing the carrier webs from the vertically suspended laminated discrete anode prior to the first and second discrete juxtaposing step.

25. The method according to claim 23, further comprising the step of heating the first and second discrete cathodes sufficiently for adhering to the exposed surfaces of the first and second separator webs, respectively.

26. The method according to claim 23, wherein the first and second discrete cathodes laminating step comprises the step of laminating at preselected temperatures, pressures, and time periods at multiple laminating positions.

27. The method according to claim 23, further comprising the step of cutting the first and second separator webs for liberating a discrete battery cell therefrom.

28. A method of manufacturing a battery cell comprising:
unwinding anode material from an anode material web coil stock;
vertically suspending the anode material web;
forming a discrete anode from the anode material web;
unwinding first and second separator webs carried by first and second carrier webs, respectively;
juxtaposing the discrete anode between exposed surfaces of the first and second separator webs;
vertically suspending the first and second carrier webs for longitudinally extending the first and second separator webs by a force of gravity for smoothing out separator web surfaces adjacent the discrete anode carried therebetween;
laminating the first and second separator webs to the discrete anode for forming a laminated anode carried by the first and second separator webs;
rewinding the first and second carrier webs onto first and second carrier web rewind spools for removing the first and second carrier webs from the vertically suspended first and second separator webs, respectively;
unwinding first and second cathode material webs from first and second cathode material web coil stock;
vertically suspending each of the first and second cathode material webs;
forming first and second discrete cathodes from the first and second cathode material webs, respectively;
juxtaposing the first and second discrete cathodes at exposed outside surfaces of the vertically suspended first and second separator webs, wherein the first and second cathodes are in alignment with the laminated anode carried therebetween;
unwinding third and fourth carrier webs for vertically carrying the first and second discrete cathodes, first and second separators, and laminated anode juxtaposed combination therebetween;
laminating the first and second discrete cathodes to the vertically suspended first and second separator webs for forming a laminated battery cell carried by the first and second separator webs;
rewinding the third and fourth carrier webs onto third and fourth carrier web rewind spools for removing the third and fourth carrier webs from the vertically suspended laminated battery cell carried by the first and second separator webs; and
cutting the first and second separator webs for liberating a discrete battery cell therefrom.

29. The method according to claim 28, wherein the discrete anode juxtaposing step comprises the step of heat sealing the first separator web to the second separator web along a line adjacent the discrete anode.

30. The method according to claim 28, wherein each of the carrier webs comprises a mylar film.

31. The method according to claim 28, wherein the discrete anode and discrete cathodes forming steps each comprise the step of die punching the vertically suspended anode and cathode material webs, respectively.

32. The method according to claim 28, wherein each of the laminating steps comprise the step laminating at preselected temperatures, pressures, and time periods at multiple laminating positions.

33. The method according to claim 28, wherein each of the web unwinding and rewinding steps comprise the steps of:
rotatably driving a coil stock comprising the web; and
controlling tension within the web.

34. A method of manufacturing a battery cell comprising the steps of:
vertically suspending a coated copper grid web;
die punching the vertically suspended, coated copper grid web for forming a discrete anode;
picking the discrete anode from the coated copper grid web and placing the discrete anode onto the first separator web carried on a first separator web carrier;
feeding a second separator web carried on a second separator web carrier onto the discrete anode for juxtaposing the discrete anode between the first and second separator webs, with the first and second separator webs carried between the first and second separator carrier webs, respectively;
attaching the first separator web to the second separator web for fixing the discrete anode therebetween;
vertically suspending the first and second separator webs for longitudinally extending the first and second separator webs by a force of gravity for smoothing out web surfaces adjacent the discrete anode carried therebetween;
laminating the first and second separator webs to the discrete anode for forming a laminated anode carried within the first and second separator webs, respectively;
removing the first and second separator carrier webs from the first and second separator webs for uncovering outside surfaces of the first and second separator webs;
vertically suspending the first coated aluminum grid web;
die punching the vertically suspended, first coated aluminum grid web for forming a first discrete cathode;
picking the first discrete cathode from the vertically suspended, first coated aluminum grid web;
picking the second discrete cathode from the vertically suspended second coated aluminum grid web;
heating the first and second discrete cathodes sufficiently for adhering to the separator web;
placing the heated first and second discrete cathodes onto the vertically suspended first and second separator webs, respectively;
attaching the first and second battery cell carrier webs to the first and second separator webs having the first and second discrete cathodes attached thereon and the discrete anode sandwiched therebetween;
laminating the first and second discrete cathodes to the first and second separator webs for placing the discrete anode therebetween thus forming a laminated battery cell carried between the first and second battery cell carrier webs;
removing the first and second battery cell carrier webs from the first and second separator webs for uncovering the laminated battery cell;
cutting a discrete laminated battery cell from the first and second separator webs; and
picking the discrete laminated battery cell from the vertically suspended first and second separator webs.

35. A method of manufacturing a battery cell comprising the steps of:
providing a coated copper grid web on an anode coil stock roll;
rotatably driving the anode coil stock roll for unwinding the coated copper grid web therefrom;
feeding the copper grid web to an anode web indexing conveyor for guiding the copper grid web into a vertical orientation;
controlling tension within the coated copper grid web between the anode coil stock roll and the anode web indexing conveyor;
vertically suspending the coated copper grid web;
die punching the vertically suspended, coated copper grid web for forming a discrete anode;
providing an anvil having a horizontal surface;
providing a first separator web coated onto a first separator carrier web of a first separator coil stock roll;
rotatably driving the first separator coil stock roll for unwinding the first separator carrier web and thus the first separator web therefrom;
feeding the first separator web onto the horizontal surface of the anvil, wherein the carrier web is positioned between the horizontal surface and the separator web;
picking the discrete anode from the coated copper grid web and placing the discrete anode onto the first separator web;
incrementally advancing the first separator carrier web;
providing a second separator web coated onto a second separator carrier web of a second separator coil stock roll;
rotatably driving the second separator coil stock roll for unwinding the second separator web therefrom;
feeding the second separator carrier web onto the horizontal surface of the anvil for juxtaposing the discrete anode between the first and second separator webs, with the first and second separator webs carried between the first and second separator carrier webs, respectively;
controlling tension within the first and second separator webs between the anvil and the first and second separator coil stock rolls, respectively;
attaching the first separator web to the second separator web for fixing the discrete anode therebetween;
advancing the first and second separator carrier webs further downstream;
vertically suspending the first and second separator webs for longitudinally extending the first and second separator webs by a force of gravity for smoothing out web surfaces adjacent the discrete anode carried therebetween;
laminating the first and second separator webs to the discrete anode for forming a laminated anode carried within the first and second separator webs, respectively;
incrementally advancing the laminated anode downstream within the first and second separator carrier webs;
removing the first and second separator carrier webs from the first and second separator webs for uncovering outside surfaces of the first and second separator webs;
winding the first and second separator carrier webs onto first and second rewind storage spools;
providing a first coated aluminum grid web on a first cathode coil stock roll;
rotatably driving the first cathode coil stock roll for unwinding the first coated aluminum grid web therefrom;
feeding the first aluminum grid web to a first cathode indexing conveyor for guiding the first aluminum grid web into a vertical orientation;
controlling tension within the first coated aluminum grid web between the first cathode coil stock roll and the first cathode web indexing conveyor;
vertically suspending the first coated aluminum grid web;
die punching the vertically suspended, first coated aluminum grid web for forming a first discrete cathode;
providing a first cathode horizontal conveying surface;
picking the first discrete cathode from the vertically suspended, first coated aluminum grid web and placing the first discrete cathode onto the first cathode horizontal conveying surface;
horizontally conveying the first discrete cathode downstream for placing the first discrete cathode proximate the exposed surface of the first, vertically suspended separator web;
providing a second coated aluminum grid web on a second cathode coil stock roll;
rotatably driving the second cathode coil stock roll for unwinding the second coated aluminum grid web therefrom;
feeding the second aluminum grid web to a second cathode indexing conveyor for guiding the second aluminum grid web into a vertical orientation;
controlling tension within the second coated aluminum grid web between the second cathode coil stock roll and the second cathode web indexing conveyor;
vertically suspending the second coated aluminum grid web;
die punching the vertically suspended, second coated aluminum grid web for forming a second discrete cathode;
providing a second cathode horizontal conveying surface;
picking the second discrete cathode from the vertically suspended second coated aluminum grid web and placing the second discrete cathode onto the second cathode horizontal conveying surface;
horizontally conveying the second discrete cathode downstream for placing the second discrete cathode proximate the exposed surface of the second, vertically suspended separator web;
picking the first and second discrete cathodes from the first and second horizontally conveying surfaces, respectively;
heating the first and second discrete cathodes sufficiently for adhering to the separator web;
placing the heated first and second discrete cathodes onto the vertically suspended first and second separator webs, respectively;
vertically conveying downstream the first and second separator webs having the discrete anode laminated therebetween and the first and second discrete cathodes attached on outside surfaces thereof;
providing first and second battery cell carrier webs onto first and second battery cell carrier storage spools;
attaching the first and second battery cell carrier webs to the first and second separator webs having the first and second discrete cathodes attached thereon and the discrete anode sandwiched therebetween;
laminating the first and second discrete cathodes to the first and second separator webs for placing the discrete anode therebetween thus forming a laminated battery cell carried between the first and second battery cell carrier webs;
incrementally advancing the laminated battery web downstream with the first and second battery cell carrier webs;
removing the first and second battery cell carrier webs from the first and second separator webs for uncovering the laminated battery cell;
vertically suspending the laminated battery cell;
cutting a discrete laminated battery cell from the first and second separator webs;
picking the discrete laminated battery cell from the vertically suspended first and second separator webs;
placing the discrete battery cell onto a discharge conveyor; and
conveying the discrete battery cell downstream for use in manufacturing a battery.

36. A battery cell manufacturing apparatus comprising:
a first vacuum conveyor and edge guide for vertically suspending an anode material web;
first die punch for forming a discrete anode from the anode material web;
separator supply for providing a separator web;
means operable with the separator supply and first die punch for positioning the discrete anode between first and second separator webs;
a first laminator for laminating the first and second separator webs to the discrete anode for forming a laminated anode carried by the first and second separator webs, the first laminator operable for vertically receiving the first and second separator webs vertically suspended for longitudinally extending the first and second separator webs by a force of gravity for smoothing out web surfaces adjacent the discrete anode carried therebetween prior to lamination of the separator webs ti the discrete anode;
second and third vacuum conveyors and edge guides for vertically suspending first and second cathode material webs therefrom;
second and third die punches for forming first and second discrete cathodes from each of the cathode material webs, respectively;
means for positioning the first and second discrete cathodes onto exposed outside surfaces of the vertically suspended first and second separator webs, wherein the first and second cathodes are in alignment with the laminated anode carried therebetween;
a second laminator for laminating the first and second discrete cathodes to the vertically suspended first and second separator webs for forming a laminated battery cell carried by the first and second separator webs, the second laminator operable with the positioning means for vertically receiving the first and second separator webs having the first and second discrete cathodes carried thereon; and
a cutter positioned for receiving the first and second separator webs having the discrete cathodes laminated thereto, the cutter operable for longitudinally and transversely cutting the first and second separator webs for liberating a discrete battery cell therefrom.

37. The apparatus according to claim 36, further comprising an anode material web and a cathode material web formed from coated copper grid material and coated aluminum grid material, respectively.

38. The apparatus according to claim 36, further comprising;
an anode coil stock roll for carrying the anode material web thereon;
driving means for rotatably driving the anode coil stock roll for unwinding the anode material web therefrom; and
tension controlling means operable with the anode material web between the anode coil stock roll and the anode web vacuum conveyor.

39. The apparatus according to claim 36, wherein the discrete anode positioning means comprise:
an anode horizontal support surface;
first and second carrier webs for carrying the first and second separator webs thereon, respectively, the first and second carrier webs stored on first and second separator coil stock rolls, respectively; and
means for rotatably driving the first and second separator coil stock rolls for unwinding the first and second carrier webs and thus the first and second separator webs, respectively therefrom.
means for feeding the first carrier web onto the anode horizontal support surface, wherein the first carrier web is positioned between the anode horizontal support surface and the first separator web; and
means for feeding the second carrier web onto the first carrier web carried on the anode horizontal support surface, wherein the second carrier web and the first carrier web carry the first and second separator webs and the discrete anode therebetween.

40. The apparatus according to claim 39, further comprising tension controlling means operable with the first and second separator webs between the anode support surface and the first and second separator coil stock rolls, respectively.

41. The apparatus according to claim 39, further comprising heat sealer for attaching the first separator web to the second separator web for fixing the discrete anode therebetween.

42. The apparatus according to claim 39, further comprising:
first and second carrier web rewind spools; and
rewinding means for removing the first and second carrier webs from the first and second separator webs for exposing outside surfaces of the first and second separator webs and rewinding the first and second carrier webs onto the first and second carrier web rewind spools.

43. The apparatus according to claim 36, further comprising:
first and second cathode material webs on first and second cathode coil stock roll;
driving means for rotatably driving the first and second cathode coil stock roll for unwinding the first and second cathode material webs, respectively therefrom; and
means for feeding the first and second cathode material webs to second and third vacuum conveyors and edge guides.

44. The apparatus according to claim 43, wherein the first, second and third vacuum conveyors comprise indexing means for advancing the webs downstream in a preselected incremental manner.

45. The apparatus according to claim 43, further comprising means for controlling tension within the first and second cathode material web between the first and second cathode coil stock rolls and the second and third cathode web vacuum conveyors, respectively.

46. The apparatus according to claim 36, wherein the first and second discrete cathode positioning means comprise:
first and second vacuum indexing conveyors for horizontally conveying the first and second discrete cathodes, respectively, for placing the first and second discrete cathodes proximate the first and second, vertically suspended separator webs, respectively;
means for picking the first and second discrete cathodes from the vertically suspended, first and second cathode material webs and placing the first and second discrete cathodes onto the first and second cathode horizontal conveyors, respectively; and
means for picking the first and second discrete cathodes from the horizontal conveyors for placing the first and second discrete cathodes onto the exposed vertically suspended surfaces of the first and second separator webs.

47. The apparatus according to claim 36, further comprising a heater for heating the first and second discrete cathodes sufficiently for adhering to the exposed surfaces of the first and second separator webs, respectively.

48. The apparatus according to claim 36, further comprising:
first and second carrier webs for carrying the first and second discrete cathodes, first and second separators, and laminated anode juxtaposed combination therebetween for carrying the combination into the second laminator; and
means for removing the first and second carrier webs from the laminated battery cell prior to operation with the cutter.

49. The apparatus according to claim 36, further comprising means for picking the discrete laminated battery cell from the vertically suspended first and second separator webs and placing the discrete battery cell onto a discharge conveyor.

50. The apparatus according to claim 36, wherein each of the laminators comprise:
a first laminating position having a first preselected temperature and a first preselected pressure for a first preselected time period; and
a second laminating position downstream the first laminating position, the second laminating position having a second preselected temperature and a second preselected pressure for a second preselected time period.

51. The apparatus according to claim 50, wherein each of the laminators comprise a third laminating position downstream the first and second laminating positions, the third second laminating position having a third preselected temperature and a third preselected pressure for a third preselected time period.
